(19) United States
(12) Patent Application Publication
(10) Pub. No.: US 2022/0248724 A1
(43) Pub. Date: Aug. 11, 2022

(54) COMPOSITION FOR REDUCING UNPLEASANT FISHY OR MEAT ODOR

(71) Applicant: CJ CHEILJEDANG CORPORATION, Seoul (KR)

(72) Inventors: Jae Sung SHIM, Suwon-si, Gyeonggi-do (KR); Ji Young OH, Suwon-si, Gyeonggi-do (KR); Hee Jeong LIM, Suwon-si, Gyeonggi-do (KR)

(73) Assignee: CJ CHEILJEDANG CORPORATION, Seoul (KR)

(21) Appl. No.: 17/617,488

(22) PCT Filed: Nov. 6, 2020
(86) PCT No.: PCT/KR2020/015551

§ 371 Date: Dec. 8, 2021

(30) Foreign Application Priority Data
Nov. 8, 2019 (KR) 10-2019-0142991
Nov. 8, 2019 (KR) PCT/KR2019/015211
Nov. 6, 2020 (KR) 10-2020-0147788

(51) Int. Cl. A23L 5/20; A23L 27/00; C12J 1/00

(52) U.S. Cl. CPC A23L 5/27; A23V 2002/00; C12J 1/00; A23L 27/84

(57) ABSTRACT

The present application relates to: a composition for reducing bad odors, comprising polyphenol, ethanol, and organic acid; and a method for reducing bad odors, comprising a step of adding the composition to a product that has a bad odor.

### TECHNICAL FIELD

### Technical Field

The present application relates to a composition for reducing an off-flavor, the composition containing polyphenol, ethanol, and an organic acid.

### Background Art

A fishy odor is caused by complex factors such as the generation of trimethylamine (TMA) and oxidation of unsaturated fatty acids during the spoilage process. In particular, TMA, which is also used as an indicator of the freshness of seafood, is rarely present in fresh flesh, but it is known that after death, the odorless trimethylamine oxide (TMAO) component is reduced by the action of bacterial enzymes to TMA, which causes a fishy odor. In general, as a method of adding an acid to neutralize basic TMA in order to remove a fishy odor, there is a method using mainly vinegar to remove a fishy odor. However, due to the unique and strong flavor, vinegar has a drawback that the use amount is limited.

Conventional various technologies for removing a fishy odor have been developed (Korean Patent No. 10-1928965, Korean Patent No. 10-1647778, and Korean Patent Publication No. 10-2019-0055941), but the effect of reducing a fishy odor was limited.

### Prior Art Documents

### Patent Documents

Korean Patent No. 10-1928965

Korean Patent No. 10-1647778

Korean Patent Publication No. 10-2019-0055941

### DISCLOSURE OF THE INVENTION

### Technical Problem

To overcome the above-described problem of conventional technologies, an object of the present application is to provide a composition for reducing an off-flavor, which: has a very excellent effect of reducing trimethylamine (TMA), which is a fishy odor-causing material; when being applied to cooking, effectively removes fishy and unpleasant odors and gives flavors; furthermore, is capable of being easily applied to processed foods, such as canned food, fish food, home meal replacements.

### Technical Solution

According to an aspect of the present application, there is provided a composition for reducing an off-flavor, the composition containing polyphenol, ethanol, and an organic acid.

According to another aspect of the present application, there is provided a method for reducing an off-flavor, the method comprising adding a composition containing polyphenol, ethanol, and an organic acid to a material generating the off-flavor.

### Advantageous Effects

The composition of the present application has a very excellent ability to reduce trimethylamine (TMA), which is a fishy odor-causing material, and when being applied to cooking, can effectively remove a fishy odor and give flavors, furthermore, can be easily applied to processed foods, such as canned food, fish food, HMR (home meal replacements).

However, the effects of the present application are not limited to the above-mentioned effects and other effects not mentioned will be clearly understood from the following description by a person skilled in the art.

### BRIEF DESCRIPTION OF THE DRAWINGS

FIG. 1 is a graph showing the results of measuring the TMA-reducing effect of the compositions of Examples and Comparative Examples of the present application. (Values are presented as the mean±SD (n=3). *p<0.05, **p<0.01, ***p<0.001 compared to the control).

FIG. 2 is a graph showing the results of measuring the TNA-reducing effect of the compositions of Examples and Comparative Examples of the present application. (Values are presented as the mean±SD (n=3). *p<0.05, **p<0.01, ***p<0.001 compared to the control).

### MODE FOR CARRYING OUT THE INVENTION

Hereinafter, the present application will be specifically described.

According to one aspect of the present application, there is provided a composition for reducing an off-flavor, containing polyphenol, ethanol, and an organic acid.

The term “polyphenol” as used in the present application refers to a compound containing one or more phenols having one or more hydroxyl groups in a molecule. The “polyphenol” is a concept including not only the polyphenol itself but also its derivatives, such as glycosides, alkylated compounds, esterified compounds, and the like.

The polyphenol may include, without limitation, any polyphenol that brings about the off-flavor reduction, the purpose of the present application. Specifically, examples of polyphenol that can be used in the present application include, without limitation, phenolic acids, flavonoids, stilbenes, lignin, etc. For example, the polyphenols include, but are not limited to, isorhamnetin, isorhamnetin glycosides, catechin, epicatechin, gallocatechin, epicatechin gallate, epigallocatechin, epigallocatechin gallate, ellagic acid, catechol, caffeic acid, caffeic esters, chlorogenic acid, kaempferol, kaempferol glycosides, quercetin, quercetin glycosides, quercetagenin, genistin, genistin glycoside, tannic acid, anthocyanin, hydroquinone, hesperetin, hesperidin, gallic acid, gallic esters (lauryl gallate, propyl gallate, butyl gallate), 4-methylcatechol, 5-methylcatechol, 4-methoxycatechol, 5-methoxycatechol, methylcatechol-4-carboxylic acid, 2-methylresorcinol, methylresorcinol, lignin, limocitrin, limocitrin glycosides, limocitrol, luteolin, luteolin glycosides, luteolinidin, luteolinidin glycosides, rutin, resorcin, resveratrol, resorcinol, leukocyanidin, leukodelphinidin, quinic acid, and the like.

Specifically, the polyphenol in the present application may be one or a combination of two or more selected from the group consisting of chlorogenic acid and caffeic acid.

In the present application, the chlorogenic acid is a compound formed by connecting caffeic acid and quinic acid by an ester bond and represented by Formula I below:

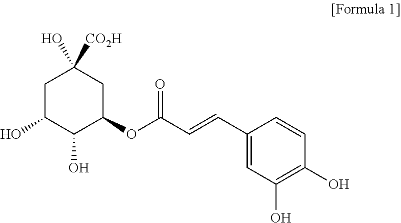 [SMILES: O=C(/C=C/c1ccc(O)c(O)c1)O[C@@H]1C[C@](O)(C(=O)O)C[C@@H](O)[C@H]1O]

In the present application, the caffeic acid is a compound classified as hydroxycinnamic acid and represented by Formula 2 below:

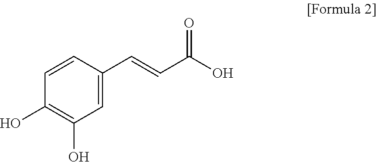 [SMILES: O=C(O)/C=C/c1ccc(O)c(O)c1]

In the present application, the polyphenol may be one derived from natural products as well as an artificially synthesized one.

Specifically, one separated and purified from the natural product by a known method in the art, for example, an extraction method, or one derived from fermented products of the natural product may be used. Specifically, one derived from fermented vinegar may be used.

The fermented vinegar includes one prepared by a known fermentation method. For example, the fermented vinegar may be obtained through primary fermentation of sugars such as glucose to ethanol and secondary fermentation of ethanol to acetic acid.

The natural product may include, without limitation, any substance containing polyphenol, but it may be a plant. Specifically, examples of the plant include aloe, anise seeds, elder, eleutherococcus, psyllium, orange flower, allspice, oregano, valerian, chamomile, capsicum pepper, cardamon, cassia, garlic, caraway seeds, clove, cumin seeds, kola, coriander seeds, Rhus lavanica, saffron, zanthoxylum, juniper berry, cinnamon, ginger, star anise, St. Johns wart, celery seed, savory, sesame, pieplant, tarragon, turmeric, thistle, dill seed, nutmeg, nettle, hibiscus, hamamelis, birch, basil, bitter orange, fennel, primrose, fenugreek, verbena, bay laurel, hop, boldo, horseradish, poppy seed, gallnut, marigold, marrow, marjoram, mustard, Millefeuille, mint leaves, melissa, mace, lindane, gentian, rosehip, rosemary, Rosmarinus officinalis, sunflower seeds, grape pericarp, apple, carrot leaves, banana, strawberry, apricot, peach, plum, pineapple, Nashi pear, persimmon, cherry, papaya, mango, avocado, melon, loquat, fig, kiwi, prune, blueberry, black berry, raspberry, cranberry, coffee beans, cacao beans, grape seeds, grape fruits seeds, pecan nut, cashew nut, chestnut, coconut, peanut, walnut, green tea leaves, black tea leaves, oolong tea leaves, tobacco, perilla leaves, garden thyme, sage, lavender, spearmint, peppermint, spotted thistle, hyssop, sweet basil, marigold, dandelion, artichoke, Matricaria chamomille, Agrimonia pilosa var. japonica, licorice, anise, yarrow, eucalyptus, wormwood, balm, Angelica pubescens, fenugreek, Capsicum annuum var. angulosum, fennel, red pepper, coriander seeds, caraway seeds, fennel seeds, ginger, horseradish, Origanum majorana, Origanum valgare, mustard, parsley, pepper, savory, tarragon, queen lily, wasabi, dill seeds, citrus fruits, and the like.

In the present application, the polyphenol may be included in a content of 0.003 to 0.1 parts by weight, based on 100 parts by weight of ethanol in the composition, but the content of the polyphenol is not limited thereto.

Specifically, the content of the polyphenol may be in a range consisting of one lower limit selected from 0.003 parts by weight, 0.004 parts by weight, 0.005 parts by weight, 0.006 parts by weight, 0.007 parts by weight, 0.0075 parts by weight, 0.008 parts by weight, and 0.0085 parts by weight, and/or one upper limit selected from 0.1 parts by weight, 0.09 parts by weight, 0.08 parts by weight, 0.07 parts by weight, 0.06 parts by weight, 0.055 parts by weight, 0.05 parts by weight, 0.045 parts by weight, 0.04 parts by weight, 0.035 parts by weight, 0.03 parts by weight, 0.025 parts by weight, 0.02 parts by weight, based on 100 parts by weight of ethanol.

For example, the content of the polyphenol may be in a range of 0.003 to 0.1 parts by weight, 0.004 to 0.09 parts by weight, 0.004 to 0.08 parts by weight, 0.007 to 0.06 parts by weight, 0.0075 to 0.055 parts by weight, 0.008 to 0.05 parts by weight, 0.0085 to 0.045 parts by weight, 0.0085 to 0.04 parts by weight, 0.0085 to 0.035 parts by weight, 0.0085 to 0.03 parts by weight, 0.0085 to 0.025 parts by weight, or 0.0085 to 0.02 parts by weight, based on 100 parts by weight of ethanol. When the content of the polyphenol is in the above-described range, the effect of reducing an off-flavor can be exhibited.

The content of the polyphenol may be a total content of chlorogenic acid and caffeic acid.

In the present application, the polyphenol may be included in a content of 0.2 to 8 ppm, based on the total weight of the whole composition, but the content of the polyphenols is not limited thereto.

Specifically, the content of the polyphenol may be in a range consisting of one lower limit selected from 0.2 ppm, 0.25 ppm, 0.3 ppm, 0.35 ppm, 0.4 ppm, 0.45 ppm, 0.5 ppm, 0.55 ppm, and 0.6 ppm, and/or one upper limit selected from 8 ppm, 7.9 ppm, 7.7 ppm, 7.6 ppm, 7.5 ppm, 7.4 ppm, 7.3 ppm, 7.2 ppm, 7.1 ppm, 7 ppm, 6.9 ppm, 6.8 ppm, 6.7 ppm, 6.6 ppm, 6.5 ppm, 6.4 ppm, 6.3 ppm, 6.2 ppm, 6.1 ppm, and 6 ppm, based on the weight of the whole composition.

For example, the content of the polyphenol may be in a range of 0.2 ppm to 8 ppm, 0.25 ppm to 7.5 ppm, 0.3 ppm to 7 ppm, 0.35 ppm to 6.7 ppm, 0.4 ppm to 6.6 ppm, 0.45 ppm to 6.5 ppm, 0.5 ppm to 6.4 ppm, 0.55 ppm to 6.3 ppm, 0.6 ppm to 6.2 ppm, 0.6 ppm to 6.1 ppm, or 0.6 ppm to 6 ppm, based on the weight of the whole composition. When the content of the polyphenol is in the above-described range, the effect of reducing an off-flavor can be exhibited.

The content of the polyphenol may be a total content of chlorogenic acid and caffeic acid.

In the present application, the chlorogenic acid may be included in a content of 0.2 to 6 ppm, based on the total weight of the whole composition, but the content of the chlorogenic acid is not limited thereto.

Specifically, the content of the chlorogenic acid may be in a range consisting of one lower limit selected from 0.2 ppm, 0.25 ppm, 0.3 ppm, 0.35 ppm, and 0.4 ppm, and/or one lower limit selected from 6 ppm, 5.8 ppm, 5.5 ppm, 5 ppm, 4.8 ppm, 4.6 ppm, 4.4 ppm, 4.2 ppm, 4 ppm, 3.5 ppm, and 3 ppm, based on the total weight of the whole composition.

For example, the content of the chlorogenic acid may be in a range of 0.2 ppm to 6 ppm, 0.25 ppm to 5 ppm, 0.3 ppm to 4.6 ppm, 0.35 ppm to 4.4 ppm, 0.4 ppm to 4.2 ppm, 0.4 ppm to 4 ppm, 0.4 ppm to 3.5 ppm, or 0.4 ppm to 3 ppm, based on the weight of the whole composition. When the content of the chlorogenic acid is in the above-described range, the effect of reducing an off-flavor can be exhibited.

In the present application, the caffeic acid may be included in a content of 0.03 to 2 ppm, based on the total weight of the whole composition, but the content of the caffeic acid is not limited thereto.

Specifically, the content of the caffeic acid may be in a range consisting of one lower limit selected from 0.03 ppm, 0.04 ppm, 0.05 ppm, 0.06 ppm, and 0.07 ppm, and/or one lower limit selected from 2 ppm, 1.8 ppm, 1.6 ppm, 1.4 ppm, 1.2 ppm, 1 ppm, and 0.8 ppm, based on the total weight of the whole composition.

For example, the content of the caffeic acid may be in a range of 0.03 ppm to 2 ppm, 0.04 ppm to 1.8 ppm, 0.05 ppm to 1.6 ppm, 0.06 ppm to 1.4 ppm, 0.07 ppm to 1.2 ppm, 0.07 ppm to 1 ppm, 0.07 ppm to 0.8 ppm, based on the weight of the whole composition. When the content of the caffeic acid is in the above-described range, the effect of reducing an off-flavor can be exhibited.

The caffeic acid may be included in the content of 1 to 50 parts by weight, based on 100 parts by weight of the chlorogenic acid. Specifically, the caffeic acid may be included in the content of 1 to 50 parts by weight, 2 to 45 parts by weight, 3 to 30 parts by weight, 4 to 25 parts by weight, or 5 to 25 parts by weight, but the content of the caffeic acid is not limited thereto.

Ethanol, which is included in the composition of the present application, is a material also called ethyl alcohol or alcoholic spirit, and the main component of an alcoholic drink.

In the present application, ethanol may be one produced by fermenting carbohydrates such as sugars or starch or one synthesized from ethylene or acetylene.

In the present application, the ethanol may be included in a content of 0.2 to 1.2 wt %, based on the total weight of the whole composition, but the content of the ethanol is not limited thereto.

Specifically, the content of the ethanol may be in a range consisting of one lower limit selected from 0.2 wt %, 0.24 wt %, 0.28 wt %, 0.32 wt %, 0.36 wt %, 0.40 wt %, 0.44 wt %, and 0.48 wt %, and/or one upper limit selected from 1.20 wt %, 1.16 wt %, 1.12 wt %, 1.08 wt %, 1.04 wt %, 1.00 wt %, 0.96 wt %, and 0.92 wt %, based on the total weight of the whole composition.

For example, the content of the ethanol may be in a range of 0.2 wt % to 1.2 wt %, 0.24 wt % to 1.16 wt %, 0.28 wt % to 1.12 wt %, 0.32 wt % to 1.08 wt %, 0.36 wt % to 1.04 wt %, 0.4 wt % to 1 wt %, 0.44 wt % to 0.96 wt %, or 0.48 wt % to 0.92 wt %, based on the weight of the whole composition. When the content of the ethanol is in the above-described range, the effect of reducing an off-flavor can be exhibited.

In an embodiment of the present application, the composition for reducing an off-taste may include an organic acid. The term “organic acid” as used in the present application refers to an organic compound having an acidic property in its broadest sense and may representatively contain a carboxylic group (—COOH) or a sulfo group (—SO3H).

Examples of the organic acid that can be included in the composition of the present application include, without limitation, low molecular organic acids, such as citric acid, malic acid, succinic acid, lactic acid, or acetic acid, or high molecular organic acids, such as ascorbic acid, or benzoic acid.

Specifically, the organic acid that can be used in the present application may be at least one selected from the group consisting of citric acid, malic acid, succinic acid, lactic acid, or acetic acid. More specifically, it is lactic acid or acetic acid. Even more specifically, it is acetic acid.

In the present application, the organic acid may be included in a content of 80 to 200 parts by weight, based on 100 parts by weight of ethanol in the composition, but the content of the organic acid is not limited thereto.

Specifically, the content of the organic acid may be in a range consisting of one lower limit selected from 80 parts by weight, 82 parts by weight, 84 parts by weight, 86 parts by weight, 88 parts by weight, 90 parts by weight, 92 parts by weight, 94 parts by weight, and 96 parts by weight, and/or one upper limit selected from 200 parts by weight, 190 parts by weight, 180 parts by weight, 170 parts by weight, 160 parts by weight, 150 parts by weight, 140 parts by weight, 130 parts by weight, and 120 parts by weight, based on 100 parts by weight of ethanol.

For example, the content of the organic acid may be 80 to 200 parts by weight, 82 to 190 parts by weight, 84 to 180 parts by weight, 86 to 170 parts by weight, 88 to 160 parts by weight, 90 to 150 parts by weight, 92 to 140 parts by weight, 94 to 130 parts by weight, 96 to 120 parts by weight, based on 100 parts by weight of ethanol.

In the present application, the organic acid may be included in a content of 0.3 to 2.4 wt %, based on the total weight of the whole composition, but the content of the organic acid is not limited thereto.

Specifically, the content of the organic acid may be in a range consisting of one lower limit selected from 0.3 wt %, 0.35 wt %, 0.4 wt %, 0.45 wt %, 0.5 wt %, 0.55 wt %, 0.6 wt %, and 0.65 wt %, and/or one upper limit selected from 2.4 wt %, 2.35 wt %, 2.3 wt %, 2.25 wt %, 2.2 wt %, 2.15 wt %, 2.1 wt %, and 2.05 wt %, based on the total weight of the whole composition.

For example, the content of the organic acid may be in a range of 0.3 wt % to 2.4 wt %, 0.35 wt % to 2.35 wt %, 0.4 wt % to 2.3 wt %, 0.45 wt % to 2.25 wt %, 0.5 wt % to 2.2 wt %, 0.55 wt % to 2.15 wt %, 0.6 wt % to 2.1 wt %, or 0.65 wt % to 2.05 wt %, based on the weight of the whole composition. When the content of the organic acid is in the above-described range, the effect of reducing an off-flavor can be exhibited.

The acetic acid may be 50 wt % or more, 70 wt % or more, 80 wt % or more, 85 wt % or more, or 90 wt % or more, based on 100 wt % of the whole organic acids. Specifically, it may be 90 to 100 wt %, 90 to 99 wt %, or 90 to 97 wt %.

In one embodiment of the present application, the organic acid may be one derived from natural products as well as an artificially synthesized one.

Specifically, one separated and purified from the natural product by a known method in the art, for example, an extraction method, or one derived from fermented products of the natural product may be used. Specifically, one derived from fermented vinegar may be used.

The fermented vinegar includes one prepared by a known fermentation method. For example, the fermented vinegar may be obtained through primary fermentation of glucose or the like to ethanol and secondary fermentation of ethanol to acetic acid.

The natural product may include, without limitation, any substance containing the organic acid, but it may be a plant. Specifically, examples of the plant include aloe, anise seeds, elder, eleutherococcus, psyllium, orange flower, allspice, oregano, valerian, chamomile, capsicum pepper, cardamon, cassia, garlic, caraway seeds, clove, cumin seeds, kola, coriander seeds, Rhus lavanica, saffron, zanthoxylum, juniper berry, cinnamon, ginger, star anise, St. Johns wart, celery seed, savory, sesame, pieplant, tarragon, turmeric, thistle, dill seed, nutmeg, nettle, hibiscus, hamamelis, birch, basil, bitter orange, fennel, primrose, fenugreek, verbena, bay laurel, hop, boldo, horseradish, poppy seed, gallnut, marigold, marrow, marjoram, mustard, Millefeuille, mint leaves, melissa, mace, lindane, gentian, rosehip, rosemary, Rosmarinus officinalis, sunflower seeds, grape pericarp, apple, carrot leaves, banana, strawberry, apricot, peach, plum, pineapple, Nashi pear, persimmon, cherry, papaya, mango, avocado, melon, loquat, fig, kiwi, prune, blueberry, black berry, raspberry, cranberry, coffee beans, cacao beans, grape seeds, grape fruits seeds, pecan nut, cashew nut, chestnut, coconut, peanut, walnut, green tea leaves, black tea leaves, oolong tea leaves, tobacco, perilla leaves, garden thyme, sage, lavender, spearmint, peppermint, spotted thistle, hyssop, sweet basil, marigold, dandelion, artichoke, Matricaria chamomille, Agrimonia pilosa var. japonica, licorice, anise, yarrow, eucalyptus, wormwood, balm, Angelica pubescens, fenugreek, Capsicum annuum var. angulosum, fennel, red pepper, coriander seeds, caraway seeds, fennel seeds, ginger, horseradish, Origanum majorana, Origanum valgare, mustard, parsley, pepper, savory, tarragon, queen lily, wasabi, dill seeds, citrus fruits, and the like.

In an embodiment of the present application, a product including the composition for reducing an off-taste of the present application may be included.

The product of the present application can be applied, without limitation, to a food product, a feed product, a household item, an industrial item, etc. Specific examples of the food product or feed product include, but are not limited to, processed grain products, vegetables, fruits, dried or cut products of vegetables, fruit juice, vegetable juice, mixed juice of vegetables and fruits, chips, noodles, processed livestock food, processed seafood, processed dairy products, fermented milk food products, microbial fermented food, confectionery and bakery, seasonings, processed fish/meat products, acidic beverages, processed foods, convenience foods, licorice, herbs, insect feed, livestock feed, pet feed, etc.

Specifically, the product of the present application may be a cooking vinegar.

In the present application, the “off-flavor” refers to an odor that gives an unfavorable, unpleasant or disgusting feeling for food, caused by a component itself contained in a product or a secondary chemical change (for example, oxidation, or chemical changes caused by light or enzymes) of the component, secondary metabolites produced by microorganisms present in the product, or a substance incorporated from outside.

Specifically, the off-flavor may be a fishy odor. The fishy odor may be derived from plants or seafood, and more specifically, from fish.

Or, the off-flavor may be an unpleasant odor. The off-flavor may be an unpleasant odor generated from meat.

Examples of a material generating the off-flavor include nitrogenous compounds, sulfur compounds, lower fatty acids, carbonyl compounds, esters, phenols, alcohols, hydrocarbons, or chlorine compounds.

The nitrogenous compounds may include, without limitation, any substance that may cause an off-flavor, such as ammonia, trimethylamine, dimethylamine, piperidine, trimethyl oxide, etc., and specifically, it may be trimethylamine.

Purified water may be further included in the composition of the present application in addition to the above-described components to adjust the final weight or volume of the composition.

The composition of the present application itself may be used as a composition for reducing an off-flavor. However, by adding additional components such as sugars or seasoning components, it may be used as a sauce or applied to processed seafood products.

Examples of sugar components that can be further added to the composition of the present application may include, but are not limited to, monosaccharides, such as glucose, fructose, and galactose; disaccharides, such as sucrose, maltose, and lactose; oligosaccharides in which three or more monosaccharides are bound; and polysaccharides, such as starch and glycogen.

An amino acid component may be further added as a seasoning component to the composition of the present application. The composition of the present application may further include a ginger concentrate or a rosemary concentrate as a flavoring agent. The amino acid component of the seasoning may be derived from a natural product, produced by fermentation, or artificially synthesized.

In addition to the polyphenol components, the composition of the present application may further contain a variety of nutritional supplements, vitamins, electrolytes, flavors, colorants, pectic acid and its salts, alginic acid and its salts, organic acids, protective colloidal thickeners, pH adjusting agents, stabilizers, preservatives, glycerin, alcohols, carbonating agents, and the like.

Specifically, the composition of the present application may include vitamin A, vitamin C, vitamin D, vitamin E, vitamin B1, vitamin B2, vitamin B6, vitamin B12, niacin, biotin, folate, pantothenic acid, and the like. In addition, the composition of the present application may include minerals such as zinc (Zn), iron (Fe), calcium (Ca), chromium (Cr), magnesium (Mg), manganese (Mn), copper (Cu), and the like. In addition, the composition of the present application may include amino acids such as lysine, tryptophan, cysteine, valine, and the like. In addition, the composition of the present application may include monosaccharides, such as glucose and fructose; disaccharides such as maltose and sucrose; polysaccharides such as dextrin and cyclodextrin; and sugar alcohols, such as xylitol, sorbitol, and erythritol. In addition, the composition of the present application may include food additives, such as a preservative, including potassium sorbate, sodium benzoate, salicylic acid, sodium dehydroacetate, etc; a disinfectant, including bleaching powder and high-grade bleaching powder, sodium hypochlorite, etc.; an antioxidant, including butylhydroxyanisole (BHA), butylhydroxytoluene (BHT), etc.; a colorant, including tar pigment; a color fixing agent, including sodium nitrite and sodium acetate; a bleaching agent, including sodium sulfite; a seasoning agent, including sodium glutamate (MSG); a sweetener, including natural sweeteners such as thaumatin and stevia extract, and synthetic sweeteners such as saccharin and aspartame; a flavor, including vanillin and lactones; an inflating agent, including alum and potassium D-bitartrate; a fortifying agent, an emulsifying agent, a thickener (thickening agent), a coating agent, a gum base agent, an anti-foaming agent, a solvent, a modifier, and the like. The additive may be selected according to the type of a food and used in an appropriate amount.

According to another aspect of the present application, there is provided a method for reducing an off-flavor, comprising adding the composition of the present application to a material generating the off-flavor.

In the method for reducing an off-flavor, which is another aspect of the present application, the contents of the composition are the same as those described in one aspect of the present application, and thus will not be repeated.

Hereinafter, the present application will be described in detail through Examples.

However, the following Examples specifically illustrate the present application, and the contents of the present application are not limited by the following Examples.

### EXPERIMENTAL EXAMPLE 1

### Preparation of Compositions for Removing a Fishy Odor

1. Experimental Materials

Chlorogenic acid and caffeic acid used as polyphenol in the experiment were purchased from Sigma-Aldrich company (USA) and used. Alcoholic spirit (containing 95% (v/v) of ethanol) used as ethanol was purchased from Woori ethanol supplies company. Acetic acid was purchased from Daejung chemicals & metals, Co., Ltd. Purified water was purchased from J.T. Baker and used.

2. Composition of the Compositions

The compositions for removing a fishy odor were prepared in the composition shown in Table 1 below. The trimethylamine (TMA)-reducing effect was determined for each prepared composition (Examples and Comparative examples).

TABLE 1

| | Comparative | Comparative | Camparative | | | | Comparative | Purified |
|---|---|---|---|---|---|---|---|---|
| Classification | example 1 | example 2 | example 3 | Example 1 | Example 2 | Example 3 | example 4 | water |
| Acetic acid | — | 0.70 | 0.70 | 0.70 | 0.70 | 0.70 | 0.70 | 0.00 |
| (%) | | | | | | | | |
| Ethanol | 0.70 | — | 0.70 | 0.70 | 0.70 | 0.70 | 0.70 | 0.00 |
| (%) | | | | | | | | |
| Chlorogenic | 5.00 | 5.00 | 0.05 | 0.25 | 0.50 | 5.00 | 25.00 | 0.00 |
| acid (ppm) | | | | | | | | |
| Caffeic | 1.00 | 1.00 | 0.01 | 0.05 | 0.10 | 1.00 | 5.00 | 0.00 |
| acid (ppm) | | | | | | | | |

### EXPERIMENTAL EXAMPLE 2

### Determination of the Trimethylamine (TMA)-Reducing Effect

1. Determination of the Fishy Odor-Reducing Effect

The flesh of the fresh mackerel purchased on the market was separated and homogenized with a mixer. 6% (w/w) of the sample of the composition prepared in Experimental example 1 was added and marinated for 30 minutes or more. The mackerel treated with each sample was heated at about 200° C. for about 20 minutes. During heating, the mackerel was turned over so that it did not burn.

2. Analysis of Trimethylamine (TMA) Component and Content

The trimethylamine (TMA) component was determined from the polyphenol composition through the following method. For adsorption for the analysis of volatiles, SPME (Solid Phase Microextraction Fiber Holder, Supelco., Bellefonte, Pa., USA) was pretreated by using DVB/CAR/PDMS (50/30 μm). 1 g of the pretreated mackerel was put into a 20 mL EPA vial, followed by capping with PTFE/Silicon. The SPME needle was inserted into the composition-added vial and used for GC/MS analysis after adsorption for 30 minutes at 60° C.

For GC/MS analysis, Agilent gas chromatograph (GC2010 plus, Agilent, USA) was used with DB-WAX Capillary column (thickness: 0.25 μm, length: 60 m, diameter: 0.25 mm). He was used as a carrier gas, and the column oven temperature was set to be 130° C., the injection temperature was set to be 200° C., the total flow was set to be 1.10 mL/min, and the total program time was set to be 60 minutes, and then analysis was performed. The amount of TMA in the composition Was calculated by adding 3-heptanol as a standard and performing the comparative relative quantification of the contents of volatile aroma components in the sample.

3. Determination of the Trimethylamine-Reducing Effect

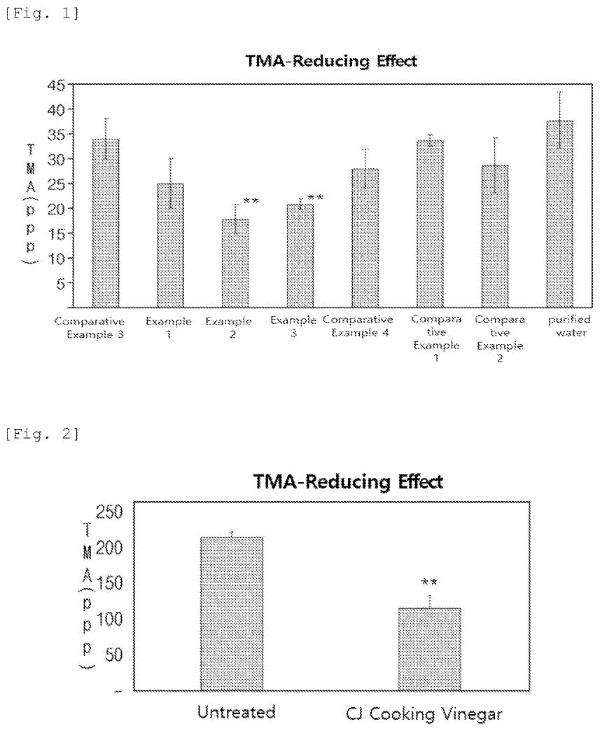

As shown in Table 2 below and FIG. 1, it can be seen that Examples 1 to 3, to which polyphenol, acetic acid, and ethanol were added, showed excellent TMA-reducing effects, compared to Comparative example 1 without the addition of acetic acid, Comparative example 2 without the addition of ethanol, and purified water without the addition of anything. Also, Comparative example 3 containing a low polyphenol content and Comparative example 4 containing an excessively high polyphenol content did not show a satisfactory level of TMA-reducing effects compared to Example 1-3.

TABLE 2

| | | Comparative | Comparative | Comparative | | | | Comparative | Purified |
|---|---|---|---|---|---|---|---|---|---|
| Classification | | example 1 | example 2 | example 3 | Example 1 | Example 2 | Example 3 | example 4 | water |
| Results | TMA | 34 | 29 | 34 | 25 | 18 | 21 | 28 | 38 |
| | (ppb) | | | | | | | | |
| | STEDV | 1 | 5 | 4 | 5 | 3 | 1 | 4 | 6 |
| | TTEST | 0.289 | 0.115 | 0.392 | 0.043 | 0.005 | 0.007 | 0.068 | — |
| | vs. | | | | | | | | |
| | purified | | | | | | | | |
| | water | | | | | | | | |

### EXPERIMENTAL EXAMPLE 3

### Preparation of Cooking Vinegar Products and Component Analysis

1. Preparation of Cooking Vinegar Products

Cooking vinegar containing 8-12% (w/w) of polyphenol-containing fermented apple vinegar (CJ CheilJedang Corp.) or twice brewing vinegar (CJ CheilJedang Corp.) and 5-7% (w/w) of apple concentrate, 25-35% (w/w) of fructose (CJ CheilJedang Corp.), 10-15% (w/w) of sugar (CJ CheilJedang Corp.), 0.5-0.7% (w/w) of alcoholic spirit (containing about 95% (v/v) of ethanol, Woori ethanol supplies company), and others (ginger or rosemary extract) were prepared. Hereinafter, the ginger-containing cooking vinegar were described as CJ cooking vinegar ginger (B2B, B2C) and the rosemary-containing cooking vinegar were described as CJ cooking vinegar rosemary (B2B, B2C).

2. Component Analysis 1—Analysis of Organic Acids

A commercially available cooking vinegar containing alcoholic spirit as an active ingredient was purchased (Lotte, hereinafter referred also to as “Lotte cooking wine (MiriM™)”). CJ cooking vinegar ginger (B2B, B2C), CJ cooking vinegar rosemary (B2B, B2C), and the commercial cooking vinegar Lotte cooking wine (Mirim™) were used for the comparative experiment of organic acid analysis. Organic acid analysis was performed by the following method.

After filtering through a 0.2 μm membrane filter, organic acids were analyzed by HPLC. For analysis, the followings were used: column, YMC pak ODS-AQ (8.3×250 mm, YMC Co., Ltd., Tokyo, Japan); column temperature, 35° C.; mobile phase, 10 mM phosphate buffer; flow rate, 0.7 mL/min; and photodiode array (PDA) detector, Waters 2414 (Waters Co.). As a standard, specific amounts of oxalic acid, citric acid, succinic acid, tartaric acid, malic acid, and lactic acid (Sigma Co.) were mixed and dissolved in distilled water to use as a standard solution. The organic acid components in the sample and the standard were identified by comparing the retention time (tR). The respective standard calibration curve was prepared, and the content of the individual organic acid component was measured based on the peak area. The measurement results are shown in Table 3 below.

3. Component Analysis 2—Analysis of Polyphenolic Components

Polyphenolic components in CJ cooking vinegar ginger, CJ cooking vinegar rosemary, and the purchased commercial cooking vinegar Lotte cooking wine (Mirim™) were analyzed and compared. Polyphenolic component analysis was performed by the following method.

As an analytical instrument for chlorogenic acid and caffeic acid, Ultimate3000 HPLC (Thermo Dionex, USA) was used with the followings: column, Inno C-18 column (Younginbiochrom, Korea) (5 μm, 4.6×250 mm); column temperature, 30° C.; mobile phases, 0.1% TFA solution and acetonitrile; and gradient: 0-25 minutes, 10% acetonitrile; 25-30 minutes, 60% acetonitrile; 30-35 minutes, 100% acetonitrile; 35-36 minutes, 100% acetonitrile; 36-40 minutes, 10% acetonitrile. The flow rate of the solvent was 0.8 ml/min and the wavelengths of the detector were 280 nm, 340 nm, and 254 nm. The analysis results for the contents of chlorogenic acid and caffeic acid were shown in Table 4 below.

4. Experimental Results for Component Analysis

As shown in Table 3 (organic acid analysis results of cooking vinegar) and Table 4 (polyphenol analysis results of cooking vinegar) below, it was found that the existing commercial cooking vinegar had a low content of organic acids and did not contain chlorogenic acid and caffeic acid, which are polyphenolic components. (n.d. means not determined.)

TABLE 3

| | | Organic acid (g/L) | | | | | | |
|---|---|---|---|---|---|---|---|---|
| | | Citric | Malic | Succinic | Lactic | Formic | Acetic | |
| No. | Sample name | acid | acid | acid | acid | acid | acid | Total |
| 1 | CJ cooking vinegar | n.d | 0.146 | 0.032 | n.d | n.d | 5.943 | 6.121 |
| | ginger B2C | | | | | | | |
| 2 | CJ cooking vinegar | 1.182 | 0.205 | 0.029 | n.d. | n.d | 5.959 | 7.376 |
| | rosemary B2C | | | | | | | |
| 3 | CJ cooking vinegar | n.d | n.d | n.d | n.d | n.d | 5.615 | 5.615 |
| | ginger B2B | | | | | | | |
| 4 | CJ cooking vinegar | 1.167 | 0.313 | n.a. | n.d | n.d | 5.691 | 7.171 |
| | rosemary B2B | | | | | | | |
| 5 | Lotte cooking | 0.086 | n.d | n.d | 0.088 | n.d | 0.030 | 0.204 |
| | wine (Mirim ™) | | | | | | | |

TABLE 4

| | | Chlorogenic acid | Caffeic acid |
|---|---|---|---|
| No. | Product name | (ppm) | (ppm) |
| 1 | CJ cooking vinegar | 0.89 | 0.10 |
| | rosemary (B2C) | | |
| 2 | CJ cooking vinegar | 0.9 | 0.06 |
| | ginger (B2C) | | |
| 3 | CJ cooking vinegar | 1.22 | 0.15 |
| | rosemary (B2B) | | |
| 4 | CJ cooking vinegar | 0.57 | 0.08 |
| | ginger (B2B) | | |
| 5 | Lotte cooking | n.d. | n.d. |
| | wine (Mirim ™) | | |

### EXPERIMENTAL EXAMPLE 4

### Determination of the Trimethylamine-Reducing Effect of the Cooking Vinegar Product

The effect of reducing the trimethylamine (TMA) component of the CJ cooking vinegar ginger (B2B) prepared in Experimental example 3 was determined. The method for determining the trimethylamine component-reducing effect is as described in Experimental example 2. The analysis result of the trimethylamine-reducing effect was shown in Table 5 below and FIG. 2. As shown in Table 5 (the analysis result of the trimethylamine-reducing effect), it was found that CJ cooking vinegar ginger had a higher TMA-reducing effect than the untreated group.

The untreated group was treated with 6% (w/w) of purified water.

TABLE 5

| | TMA | TMA |
|---|---|---|
| Classification | (ppb) | (converted into %) |
| Untreated group | 83 | 100 |
| CJ cooking vinegar ginger | 41 | 50 |
| CJ cooking vinegar rosemary | 36 | 43 |

Although representative embodiments of the present application have been described above, the scope of the present application is not limited to the specific embodiments as described above, a person skilled in the art can change the present application within the scope described in the claims of the present application.

1. A composition for reducing an off-flavor, comprising polyphenol, ethanol, and an organic acid.

2. The composition for reducing an off-flavor of claim 1, wherein the polyphenol is at least one selected from the group consisting of chlorogenic acid and caffeic acid.

3. The composition for reducing an off-flavor of claim 1, wherein the organic acid is at least one selected from the group consisting of citric acid, malic acid, succinic acid, lactic acid, and acetic acid.

4. The composition for reducing an off-flavor of claim 1, wherein the polyphenol is derived from fermented vinegar.

5. The composition for reducing an off-flavor of claim 1, wherein the organic acid is derived from fermented vinegar.

6. The composition for reducing an off-flavor of claim 1, wherein the content of the polyphenol is 0.003 to 0.1 parts by weight based on 100 parts by weight of ethanol.

7. The composition for reducing an off-flavor of claim 6, wherein the content of the polyphenol equals to a total content of chlorogenic acid and caffeic acid.

8. The composition for reducing an off-flavor of claim 1, wherein the content of the organic acid is 80 to 200 parts by weight based on 100 parts by weight of ethanol.

9. The composition for reducing an off-flavor of claim 1, wherein the off-flavor is a fishy odor.

10. The composition for reducing an off-flavor of claim 1, wherein the off-flavor is generated by a nitrogenous compound.

11. A method for reducing an off-flavor, comprising adding the composition of claim 1 to an off-flavor-generating material.

12. A product containing the composition of claim 1.

13. The product of claim 12, which is a cooking vinegar.
